(19) United States
(12) Patent Application Publication
(10) Pub. No.: US 2021/0073737 A1
(43) Pub. Date: Mar. 11, 2021

(54) SYSTEM AND METHOD FOR PREDICTION OF JOB PERFORMANCE

(71) Applicant: JPMorgan Chase Bank, N.A., New York, NY (US)

(72) Inventors: Christopher W. FLYNN, Columbus, OH (US); Robert V. ZWINK, Columbus, OH (US); Rohan ADUR, Columbus, OH (US); Samuel D. LENTZ, New Albany, OH (US)

(21) Appl. No.: 15/652,769

(22) Filed: Jul. 18, 2017

Related U.S. Application Data
(60) Provisional application No. 62/363,485, filed on Jul. 18, 2016.

(51) Int. Cl. G06Q 10/10; G06Q 10/04; G06N 5/04; G06N 7/00

(52) U.S. Cl. CPC G06Q 10/1053; G06N 7/005; G06N 5/04; G06Q 10/04

(57) ABSTRACT

The invention relates to a computer-implemented system and method for predicting job performance. The method may comprise the steps of: receiving from a hiring manager a plurality of attributes desired in a job applicant for a job opening; storing a weight factor for one or more of the attributes; receiving a job posting from the hiring manager for the job opening; receiving a resume from each of a plurality of job applicants in response to the job posting; scanning the resumes of the job applicants to extract searchable content from the resumes; applying a predictive model to the content to generate a score for each resume indicating a predicted level of job performance for each job applicant; and generating list of job applicants ordered according to the score.

### RELATED APPLICATIONS

This application claims priority to U.S. Application No. 62/363,485, filed Jul. 18, 2016, entitled “System and Method for Prediction of Job Performance,” which is hereby incorporated by reference.

### FIELD OF THE INVENTION

The present invention relates generally to prediction of job performance, and more particularly to a method and system for automated prediction of job performance based on resume data and job description data.

### BACKGROUND

Companies often spend considerable resources to identify talented candidates for their workforce. In addition to the time spent reviewing resumes, companies must interview candidates and often send company representatives to travel to different recruiting events. Because the recruiting process generally starts with reviewing a resume, this step can have a significant impact on the time spent during the remainder of the process and can also impact the success rate of the recruiting process. Yet the resume review process is a manual process that is labor intensive and that also may vary considerably based on the attitude, bias or inexperience of the reviewer. These and other drawbacks exist with known processes.

### SUMMARY

According to one embodiment, the invention relates to a computer-implemented system and method for automatically predicting job performance. The method may be conducted on a specially programmed computer system comprising one or more computer processors, electronic storage devices, and networks. The method may comprise the steps of: receiving from a hiring manager a plurality of attributes desired in a job applicant for a job opening; storing a weight factor for one or more of the attributes; receiving a job posting from the hiring manager for the job opening; receiving a resume from each of a plurality of job applicants in response to the job posting; scanning the resumes of the job applicants to extract searchable content from the resumes; applying a predictive model to the content to generate a score for each resume indicating a predicted level of job performance for each job applicant; and generating list of job applicants ordered according to the score.

The invention also relates to a computer implemented system for automatically predicting job performance, and to a computer readable medium containing program instructions for executing a method for automatically predicting job performance.

Exemplary embodiments of the invention can provide a number of advantages to a company's recruiting efforts. For example, at recruiting events, company recruiters can evaluate the hundreds of resumes they may receive much more efficiently by scanning them into the system and using the automated process to return an ordered list of the applicants most likely to succeed. The system can also remove human bias from the interview selection process, so that the most qualified candidates with the most closely matched skill set get the interview. As a result, the recruiter or interviewer is able to identify the most promising candidates much more efficiently and accurately than by reading through all resumes and manually assigning a score. Also, because the system can scan files and recognize characters, it is not necessary for the job applicant to enter data from his or her resume into a system. The system can also be implemented on a mobile device such as an iPad using its camera, which allows an interviewer to quickly and easily take an image of a resume on location and have the system return a score essentially in real time. The predictive accuracy of the system can also be continuously improved by using machine learning and additional data. For example, human resources data on the performance of actual employees can improve the predictive modeling of job performance, data on the applicants that accepted positions can improve predictive modeling of acceptance rate, and data on each employee's duration of employment can be used to improve the prediction of attrition rate. Hence, the modeling and predictions provided by the system can offer significant advantages and insights into identification of the best candidates for job openings, the terms of job offers that are likely to be accepted, and identification of the employees who are likely to stay at the company once hired.

These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is a diagram of a system for automatically predicting job performance according to an exemplary embodiment of the invention.

FIG. 2 illustrates an example of a method for automatically predicting job performance according to an exemplary embodiment of the invention.

FIG. 3 is a diagram illustrating the architecture of a system for predicting job performance according to an exemplary embodiment of the invention.

### DETAILED DESCRIPTION

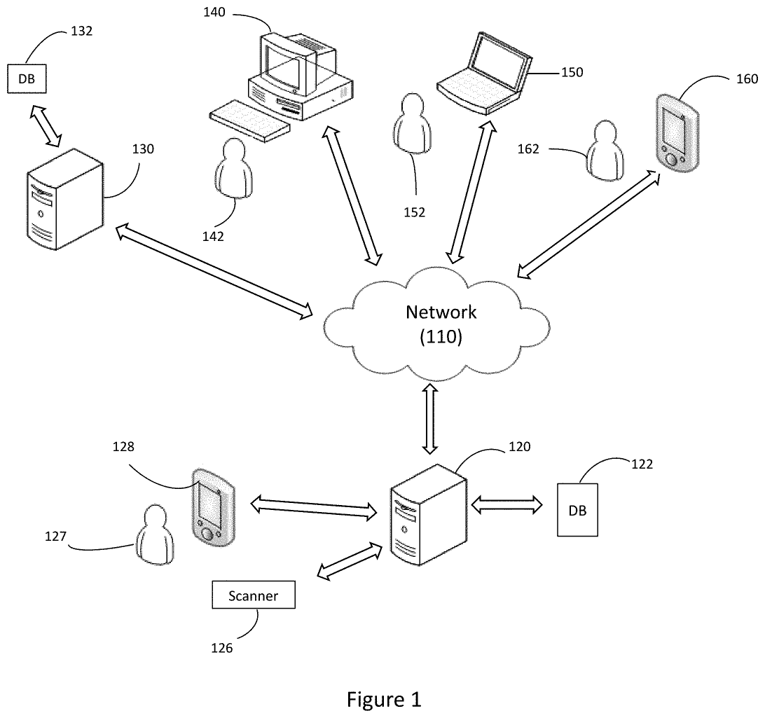

FIG. 1 is a diagram of a system for prediction of job performance according to an exemplary embodiment of the invention. As shown in FIG. 1, the system may include a network and one or more computing devices, such as servers, desktop computers, laptop computers, tablet computers, and other mobile computing devices. The system may be operated by a company or other organization in connection with its recruiting function. For simplicity, the examples set forth herein will be described in terms of a system operated by a company. However, those skilled in the art will appreciate that other types of organizations can operate and maintain the system in connection with their recruiting function.

Referring again to FIG. 1, the system may be embodied primarily in an application server 120. The application server 120 may interface with a database server 122 and/or one or more other servers owned and/or operated by the company. The database server 122 may store information on job applicants, job descriptions, and employees, for example. The application server 120 may query the database server 122 for data on a candidate and data on a specific job posting. The application server 120 may store and execute a software application for predicting job performance (sometimes referred to herein as a “Prediction App”) based on such data stored in the database server 122.

Also shown in FIG. 1 are a number of other computing devices and a network 110. The network 110 may comprise any one or more of the Internet, an intranet, a Local Area Network (LAN), a Wide Area Network (WAN), an Ethernet connection, a WiFi network, a Global System for Mobile Communication (GSM) link, a cellular phone network, a Global Positioning System (GPS) link, a satellite communications network, or other network, for example. The other computing devices, such as servers, desktop computers, laptop computers, and mobile computers, may be operated by different individuals or groups within the company, for example, and may transmit data such as job description data to the application server 120 via the network 110. For example, various data may be transmitted automatically or manually by a data server 130, a desktop computer 140 operated by an operator 142, a laptop computer 150 operated by an operator 152, and/or a tablet computer or smartphone 160 operated by an operator 162. The data transmitted by these computing devices may include, for example, specific qualifications needed in a job candidate, desired experience for a candidate, job descriptions, and employee performance data. All of the foregoing data can be transmitted to the application server 120 and stored in the database server 122.

The application server 120 may be operated by a recruiter, interviewer, or analyst 127 using a computing device such as a tablet computer 128, for example. The system may also include a scanner 126 that the recruiter 127 can use to scan resumes received from job applicants. The foregoing description is merely one example of a configuration for such systems and functions and is not intended to be limiting. An example of a method for predicting job performance will now be described.

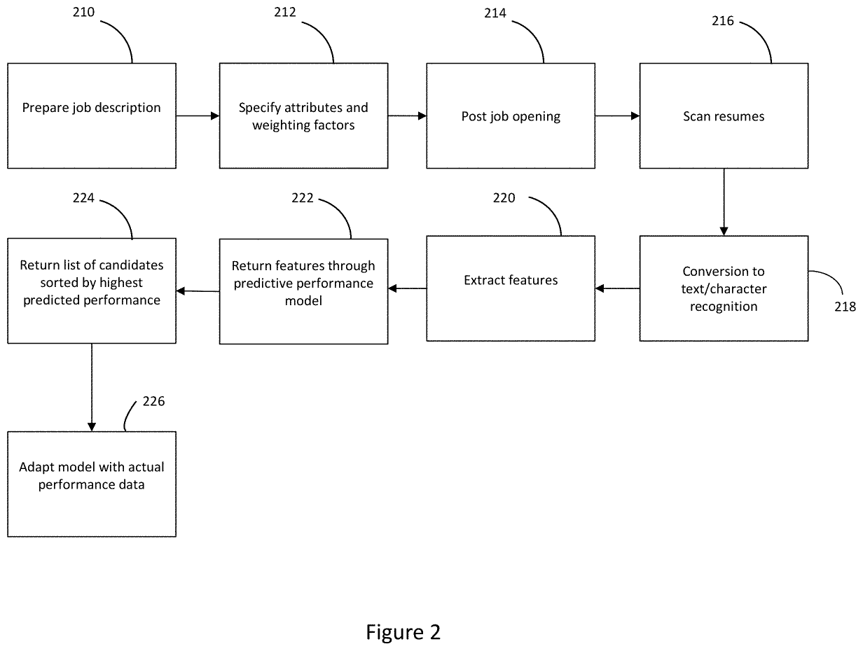

According to one embodiment of the invention, the method begins with the drafting of a job description by the company manager shown as step 210 in FIG. 2. The job description is the description to be posted or published in order to attract candidates to apply for a particular job opening. The job description will typically include the characteristics and experience that are desired or required of the applicant, such as type and level of educational degrees, specific job experience, specialized skills, number of years of industry experience, and other desired characteristics of the applicant. The job description may also include a section that describes the company in a favorable light to attract applicants by highlighting the company's achievements and resources. According to one example, a company manager 142 prepares the job description and sends it using his or her desktop computer 140 via the network 110 to the application server 120, which stores it in the database 122.

In step 212, the company manager 142 may also specify a set of required attributes for the job applicant. The attributes will be related to the job description, but may also include criteria not appearing in the job description. For example, the attributes may specify a minimum grade point average (e.g., 3.3 minimum GPA), a required school ranking threshold (e.g., school ranked in top 20% nationally), required skills (e.g., 4 years Java programming experience), and personality traits (e.g., reasonably articulate).

To enable the company manager to specify the attributes, the Prediction App may include a form that includes fields for the company manager to fill in for each attribute. The application server 120 can transmit the form to the company manager 142, e.g., via a web browser, for him or her to complete and send back with an identification of the required attributes.

The form may also include fields enabling the company manager to specify a weighting factor for one or more of the attributes. The weighting factor allows the company manager to specify the relative importance of each attribute. For example, the form may allow the company manager to enter a number between 1 and 10 for each attribute. As one example, for a computer programmer, the experience programming in a particular computer language may be more important than communication skills; whereas for a news anchor, communication skills may be much more important than GPA or educational degree. Once the company manager has completed the form specifying attributes and weighting factors, he or she can send it back to the web application server 120, which then stores the information in the database server 122. This information can then be used as input to the Prediction App.

In step 214, a recruiter posts the job description to attract candidates for the job opening. In step 216, the recruiter or interviewer receives resumes from job applicants and scans the resumes. The scanning may be accomplished with various hardware and software. For example, the interviewer may use a conventional document scanner 126 that scans each resume and creates one or more electronic files such as Adobe portable document format (pdf) files. According to one example, the interviewer may scan a stack of multiple resumes (e.g., 100) into one pdf file that is later processed by the Prediction App. Or, the interviewer may use the camera on a tablet computer such as an Apple iPad to capture an image of the resume. The latter approach has the advantage of allowing the interviewer to use a mobile or portable hardware device to scan the resumes.

Regardless of the hardware used, after the image has been captured, a character recognition software application (e.g., optical character recognition) can be used to convert the image into searchable alphanumeric characters and words in step 218. The searchable characters can be stored in a corresponding text file or they can be stored as part of the original image or pdf file. The searchable nature of the file allows the Prediction App to search and analyze each resume file.

According to one embodiment of the invention, the Prediction App comprises software modules that score resumes based on the content of the resume, the job attributes and weight factors provided by the company managers, and algorithms used to parse and analyze this input data. The Prediction App can be programmed to generate an overall score that indicates the likelihood that a particular job applicant will excel at a job that has been posted. The Prediction App examines a stack of scanned resumes, extracts important features, and runs those features through a predictive model to predict future performance. The Prediction App can then return a list of the candidates sorted by predicted performance that allows the recruiter to prioritize the review and interviewing process.

According to one specific example, a product manager at a technology company is looking to hire a sales manager with at least 5 years of experience selling software or related services, 2 years of experience selling IT to the Federal Government, a GPA of at least 3.0, B.S. in computer science, graduate of a school ranked in the top 25% nationally, experience writing mobile apps, and an outgoing personality. The product manager writes a job description and also completes the form specifying the above attributes and the relative weights for each. For example, the product manager may choose to assign a weight factor of 8 (on a scale of 0-10, with 10 being the highest) to the five years of experience selling software or related services, a weight factor of 9 for experience selling IT to the Federal Government, a weight factor of 3 for the GPA above 3.0, a weight factor of 3 for the B.S. in computer science, a weight factor of 2 for graduating from a top 25% ranked school, a weight factor of 3 for experience writing mobile apps, and a weight factor of 8 for an outgoing personality.

Alternatively or in addition, the Prediction App itself may include default weight factors that are set initially by a programmer or that have been refined over time. According to this embodiment, the product manager can opt to use the default weight parameters programmed into the Prediction App and that have been refined over time, rather than estimating what they should be without any quantitative or historical data.

The Prediction App uses parsing and text extraction techniques to identify the pertinent attributes of the job applicant from his or her resume. For example, the Prediction App may ascertain from the scanned resume that the applicant has only three years of experience selling software, no experience selling IT to the Federal Government, a GPA of 3.4, a B.A. in business management, attended at local college ranked in the bottom 50% nationally, has no experience writing mobile apps, and is likely to have an outgoing personality (e.g., based on various interests and extracurricular activities listed on the resume). The Prediction App then runs the attributes of the job applicant through a predictive model that calculates a score (e.g., 1-100) that represents predicted performance of the applicant in the posted job. In this example, the applicant may receive a relatively high score because he or she satisfies the most heavily weighted criteria, even though not satisfying some of the less weighted criteria.

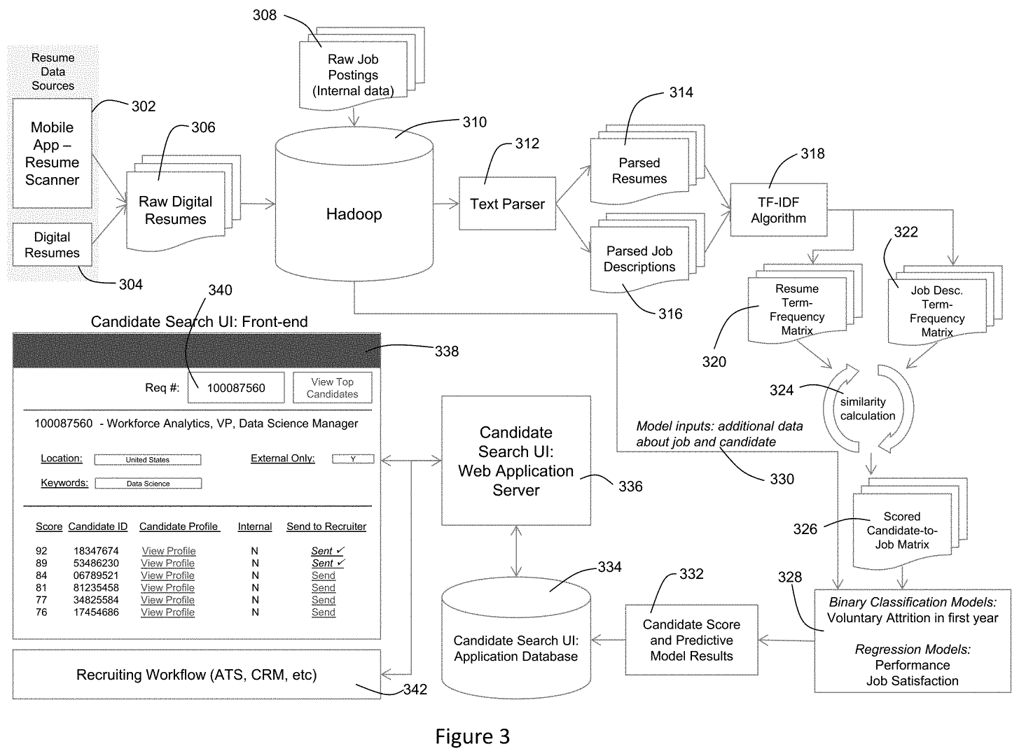

FIG. 3 illustrates an example of the architecture of the system according to an exemplary embodiment of the invention. As shown in FIG. 3, the system can include two sources of resume data, according to one example. A first source of resume data may be generated by the company manager, recruiter, interviewer, or other user with a mobile phone having a camera and mobile app 302 to capture an image of the candidate's resume. The mobile app 302 may include character recognition software (e.g., optical character recognition (OCR) or intelligent character recognition (ICR) software) to convert the image captured by the camera of the mobile device into searchable alphanumeric characters. The searchable characters can be stored in a corresponding text file or they can be stored as part of the original image or pdf file. A second source of resume data may be a digital resume 304, such as an electronic resume in Microsoft Word format or Adobe PDF format, that is sent by the job applicant. In either case, the output comprises raw digital resumes 306 which comprise searchable text.

According to one aspect of the invention, a software routine can be incorporated to prevent candidates from abusing the text parsing step for the purposes of increasing their candidate scores for a particular desired position. For example, the text parser can be programmed to remove words that a candidate may include in a resume digitally that don't appear visually. A candidate could theoretically copy and paste a job description into invisible digital text in their resume, which would cause the later TF-IDF algorithm to produce an inappropriately high score for that particular resume-to-job pair. This type of manipulation can be prevented by utilizing OCR or ICR instead of the raw digital resume data present in a file format like an Adobe PDF.

Additional input data may include raw job postings 308, which may comprise a posted job description provided by internal users of the system such as hiring managers or recruiters. The internal users may complete a form to generate and transmit the raw job postings 308 to the system, for example, or the system may be programmed to automatically retrieve the raw job postings from another server that houses that data. The raw job postings 308 and the raw digital resumes 306 are transmitted to a database 310. The database 310 may be a Hadoop database, for example, which is an open source programming framework that supports the storage and processing of very large data sets in a distributed computing environment.

The raw digital resumes 306 and raw job postings 308 are input to a text parser 312 which utilizes one or more parsing algorithms to identify and separate each of the terms (e.g., words) in the raw digital resumes 306 and raw job postings 308. The text parser 312 may utilize open-source software, for example, or other software to extract raw text from multiple document types (e.g. Adobe PDFs, MS Word, .txt files) and convert into more readable text formats (e.g. HTML). The text parser outputs parsed resumes 314 and parsed job descriptions 316.

The parsed resumes 314 and parsed job descriptions 316 are input to a module for quantifying the significance of each term (e.g., word) in the resume and job description. According to one example, a Term Frequency-Inverse Document Frequency (TF-IDF) routine is used. The TF-IDF routine calculates a numerical weight for each term in a document that represents how significant or important the term is to a document in a collection or corpus of documents. The Term Frequency (TF) value indicates how frequently a term occurs in a document and may be calculated, for example, by dividing the number of times a term appears in a document by the total number of terms in the document. The Inverse Document Frequency (IDF) value quantifies how uncommon it is for the word to appear in a document and may be calculated, for example, as the log of the total number of documents in the corpus divided by the number of documents that include the word. The TF-IDF value is then calculated for each term by multiplying the TF value by the IDF value for that term. The TF-IDF value is highest when a term appears many times in a small number of documents and lowest when the term appears in most or all of the documents in the corpus.

The TF-IDF algorithm 318 populates a resume term frequency matrix 320 and a job description term frequency matrix 322. These matrices include TF and IDF values for each term in each resume and job description. The TF and IDF values are used to calculate the TF-IDF value. They are also used to execute a similarity calculation 324 that results in a similarity score between each resume and job description. The similarity calculation can be performed with cosine similarity, for example, by summing the products of each component from both term-frequency matrices and plotting onto an orthogonal vector within a 90 degree angle. Very similar documents will have a dot-product with a very small angle, resulting in a cosine similarity measure close to 1. The result of the similarity calculation 324 is translated into a candidate score, e.g. from 1-100, that represents the similarity between a candidate's resume and a job description. The candidate scores are stored in a candidate-to-job matrix 326.

According to another aspect of the invention, additional data on the job and the candidate can be stored in the database 310 and input to one or more predictive models 328, as shown by element 330 in FIG. 3, along with the candidate score from the candidate to job matrix 326. For example, as described above in connection with step 212 of FIG. 2, additional job attributes and weight factors can be provided, e.g., using a form, by an internal user such as a hiring manager or recruiter.

Additional sources of data may be used as input to the Prediction App to improve its performance. For example, the Prediction App may receive data from the company's human resources (HR) database to evaluate, for the job applicants that were actually hired, how well they ended up performing. For example, qualitative and/or quantitative employee performance evaluation data can be compared with the performance level predicted by the Prediction App, and the model used by the Prediction App can be adjusted to more accurately predict employee performance based on actual performance scores for current employees. The results can be used to continuously optimize the predictive model with machine learning.

The additional data 330 may also include, for example, internal data elements about the job such as location, job title, manager, hours, salary, etc., and elements about the candidate such as their educational or employment histories. It may also include external data elements related to job markets, compensation trends, public reviews of the company, and other data publically available about the candidate.

According to another aspect of the invention, the Prediction App can be programmed to include functionality for predicting the attrition rate of new employees. For example, the Prediction App may be programmed to provide a percentage indicating the probability that the newly hired employee will stay with the company for at least one year if hired. Relevant input data to this portion of the predictive model may include the level of competition in the market for recruiting talented employees, the level of compensation offered by the company as compared to the market, and the potential for advancement at the company as compared to its competitors. If the new employee is being paid above market and has ample opportunity to advance, the Prediction App will indicate a low likelihood of attrition. On the other hand, if the employee, even though accepting the position, is being underpaid, has minimal advancement opportunities at the company, and there are competitors looking for talent, then the Prediction App will indicate that the likelihood of attrition is relatively high. Predictive models can be trained to target attrition at various desired intervals, for example the first 90 or 365 days of employment.

According to an exemplary embodiment of the invention, binary classification models 328 are used that incorporate algorithms including but not limited to logistic regression, random forest classifiers, support vector machines, and neural networks. These models leverage inputs from resume and job description term-frequency matrices 320 and 322, as well as additional data about jobs and candidates 330. The output may comprise either a discrete one or zero, or a continuous number (probability) between zero and one, of a particular outcome occurring for each observation. That outcome may be voluntary attrition within a particular period of time, for example, or above average performance or job satisfaction. According to one particular example, at the time a job application is received, data is input from a resume, job description and a human resources (HR) information system and passed through a set of pre-trained binary classification predictive models. The models output values (predictions) for multiple events, including voluntary attrition within the first year of employment, above-average performance rating after the first year of employment, and above-average job satisfaction after one year of employment. Models can be pre-trained based on historical data and updated on a periodic (e.g., daily) basis with new data received from an HR information system on new terminations, performance ratings, and job satisfaction scores, for example.

According to another aspect of the invention, the Prediction App can be programmed to include a functionality for predicting the likelihood that a job applicant will accept an offer for a given position. For example, the Prediction App may include modeling that evaluates the level of demand in the market for a particular applicant's skills and experience. The market demand, the offered amount of compensation, and the company stability are three data points that can be used predict whether the job applicant will accept the job offer. If the demand is high, the offered compensation is average or low, and the company is a startup, the Prediction App may predict that job applicant is very unlikely to accept. On the other hand, if market demand for the applicant's skills is moderate, the offered compensation is high, and the company is highly regarded and stable, the Prediction App will predict that the applicant is likely to accept. The predictive model used by the Prediction App can use historical data (i.e., acceptances and rejections of employment offers) to improve the model over time. In addition to macro data about the company and job market, data about the team a candidate would join, the office location, commute distance, and public transit access can also be incorporated in the model according to an exemplary embodiment of the invention.

According to another aspect of the invention, the Prediction App utilizes regression models to predict job performance and job satisfaction. Regression models for job performance and job satisfaction 328 may leverage algorithms such as linear regression, including variations using L1, L2 or elastic net regularization, for example. Algorithms such as random forests, Bayesian linear regression, and neural networks can also be used. These algorithms leverage similar data elements as the binary classification models, including inputs from resume and job description term-frequency matrices 320 and 322, as well as additional data about jobs and candidates 330. Performance and job satisfaction can be measured in different ways, with a predictive model targeting each potential methodology for measurement. For example, job performance can be specifically measured and predicted as a business-aligned metric such as total sales in the first year of employment or the customer satisfaction score received by a teller in their first year of employment. Job performance can also be measured or predicted as the performance review an employee receives from their manager for their first year of employment. Similarly, job satisfaction can be measured and predicted as an employee's response to a survey on how satisfied they are with their current position, how likely they are to remain in their position for another year, how they would rate their team or manager, or a combination of common employee-opinion-survey questions.

The candidate score and predictive model results 332 are stored in an application database 334 which may be accessed with a web server application 336 through a candidate search user interface (UI). An example of the user interface front end 338 is shown in FIG. 3. The user interface 338 allows a hiring manager, for example, to input a reference number for a job opening into a field 340 to retrieve a list of candidates that have submitted resumes and have been scored by the system. As shown in FIG. 3, the user interface displays the reference number and the job title. It also allows the user to specify a location of the job, designate whether the candidates are internal only, external only, or both, and input keywords for searching job descriptions. Once the user has entered the search parameters, he or she can click the “View Top Candidates” button to view the candidates having the highest candidate scores as calculated by the system. The user interface also allows the user to view the profile of each candidate and to send the candidate's profile to a recruiter to follow up with the candidate.

According to an exemplary embodiment of the invention, as shown in FIG. 3, when a user sends a candidate's profile to a recruiter, the system passes a message from the web application server to an Applicant Tracking System (ATS) 342 used by the recruiter. The message includes contact information of the candidate as well as information about the position for which the candidate has been recommended, the candidate's candidate-to-job score, and predictive model results. The recruiter uses this information in their existing recruiting workflow to prioritize the review of the candidate and potentially schedule introductory conversations.

According to another aspect of the invention, the Prediction App may include a functionality to allow the recruiter or interviewer to recommend an applicant to a group within the company, whether or not the group has posted a job opening. For example, an interviewer may be interviewing candidates for a computer programming job, but may realize that one of the applicants is actually a much better fit for a sales job. The Prediction App can be programmed to invite the interviewer to input comments identifying the candidate and his or her qualifications so that the relevant manager can follow up with the candidate.

Exemplary embodiments of the invention can thus provide a number of advantages to a company's recruiting efforts. For example, at recruiting events, company recruiters can evaluate the hundreds of resumes they may receive much more efficiently by scanning them into the system and using the Prediction App to return an ordered list of the applicants most likely to succeed. The system can also remove human bias from the interview selection process, so that the most qualified candidates with the most closely matched skill set get the interview. As a result, the recruiter or interviewer is able to identify the most promising candidates much more efficiently and accurately that by reading through all resumes and manually assigning a score. Also, because the Prediction App can scan files and recognize characters, it is not necessary for the job applicant to enter data from his or her resume into a system. The system can also be implemented on a mobile device such as an iPad using its camera, which allows an interviewer to quickly and easily take an image of a resume on location and have the Prediction App return a score essentially in real time. The predictive accuracy of the system can also be continuously improved by using machine learning and additional data. Human resources data on the performance of actual employees can improve the predictive modeling of job performance, data on which applicants accepted positions can improve the predictive modeling of acceptance rate, and data on each employee's duration of employment can be used to improve the prediction of attrition rate. Hence, the modeling and predictions provided by the Prediction App can offer significant advantages and insights into identification of the best candidates for job openings, the terms of job offers that are likely to be accepted, and identification of the employees who are likely to stay at the company once hired.

The foregoing examples show the various embodiments of the invention in one physical configuration; however, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. As will be appreciated by those skilled in the art, the components of the various embodiments may be arranged at any location or locations within a distributed network without affecting the operation of the respective system.

The mobile devices 128, 160 depicted in FIG. 1 may comprise a smart phone, such as an Apple iPhone, Samsung Galaxy, or Amazon Fire Phone, or a tablet computer, such as an Apple iPad or Samsung Galaxy Tab, that includes a touch screen or other interactive display. The mobile devices 128, 160 preferably include hardware and software to enable communication with a cellular network, a WiFi network, and a Bluetooth channel. The personal computing devices 130, 140, 150 may comprise a laptop computer or desktop computer, for example.

Data and information maintained by the servers shown by FIG. 1 may be stored and cataloged in one or more databases, which may comprise or interface with a searchable database and/or a cloud database. The databases may comprise, include or interface to a relational database. Other databases, such as a query format database, a Standard Query Language (SQL) format database, a storage area network (SAN), or another similar data storage device, query format, platform or resource may be used. The databases may comprise a single database or a collection of databases. In some embodiments, the databases may comprise a file management system, program or application for storing and maintaining data and information used or generated by the various features and functions of the systems and methods described herein.

Communications network, e.g., 110 in FIG. 1, may be comprised of, or may interface to any one or more of, for example, the Internet, an intranet, a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1 or E3 line, a Digital Data Service (DDS) connection, a Digital Subscriber Line (DSL) connection, an Ethernet connection, an Integrated Services Digital Network (ISDN) line, a dial-up port such as a V.90, a V.34 or a V.34bis analog modem connection, a cable modem, an Asynchronous Transfer Mode (ATM) connection, a Fiber Distributed Data Interface (FDDI) connection, a Copper Distributed Data Interface (CDDI) connection, or an optical/DWDM network.

Communications network 110 in FIG. 1 may also comprise, include or interface to any one or more of a Wireless Application Protocol (WAP) link, a Wi-Fi link, a microwave link, a General Packet Radio Service (GPRS) link, a Global System for Mobile Communication (GSM) link, a Code Division Multiple Access (CDMA) link or a Time Division Multiple Access (TDMA) link such as a cellular phone channel, a Global Positioning System (GPS) link, a cellular digital packet data (CDPD) link, a Research in Motion, Limited (RIM) duplex paging type device, a Bluetooth radio link, or an IEEE 802.11-based radio frequency link. Communications network 110 may further comprise, include or interface to any one or more of an RS-232 serial connection, an IEEE-1394 (Firewire) connection, a Fibre Channel connection, an infrared (IrDA) port, a Small Computer Systems Interface (SCSI) connection, a Universal Serial Bus (USB) connection or another wired or wireless, digital or analog interface or connection.

In some embodiments, the communication network 110 may comprise a satellite communications network, such as a direct broadcast communication system (DBS) having the requisite number of dishes, satellites and transmitter/receiver boxes, for example. The communications network may also comprise a telephone communications network, such as the Public Switched Telephone Network (PSTN). In another embodiment, communication network 110 may comprise a Personal Branch Exchange (PBX), which may further connect to the PSTN.

Although examples of mobile device 128, 160 and personal computing devices 130, 140, 150 are shown in FIG. 1, exemplary embodiments of the invention may utilize other types of communication devices whereby a user may interact with a network that transmits and delivers data and information used by the various systems and methods described herein. The mobile device and personal computing device may include a microprocessor, a microcontroller or other device operating under programmed control. These devices may further include an electronic memory such as a random access memory (RAM), electronically programmable read only memory (EPROM), other computer chip-based memory, a hard drive, or other magnetic, electrical, optical or other media, and other associated components connected over an electronic bus, as will be appreciated by persons skilled in the art. The mobile device and personal computing device may be equipped with an integral or connectable liquid crystal display (LCD), electroluminescent display, a light emitting diode (LED), organic light emitting diode (OLED) or another display screen, panel or device for viewing and manipulating files, data and other resources, for instance using a graphical user interface (GUI) or a command line interface (CLI). The mobile device and personal computing device may also include a network-enabled appliance or another TCP/IP client or other device. The mobile devices 128, 160 and personal computing devices 130, 140, 150 may include various connections such as a cell phone connection, WiFi connection, Bluetooth connection, satellite network connection, and/or near field communication (NFC) connection, for example.

As described above, FIG. 1 includes a number of servers 120, 122, 130 and user communication devices 128, 140, 150, 160, each of which may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software. The modules described above may comprise software, firmware, hardware, or a combination of the foregoing.

It is appreciated that in order to practice the methods of the embodiments as described above, it is not necessary that the processors and/or the memories be physically located in the same geographical place. That is, each of the processors and the memories used in exemplary embodiments of the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two or more pieces of equipment in two or more different physical locations. The two distinct pieces of equipment may be connected in any suitable manner. Additionally, the memory may include two or more portions of memory in two or more physical locations.

As described above, a set of instructions is used in the processing of various embodiments of the invention. The servers in FIG. 1 may include software or computer programs stored in the memory (e.g., non-transitory computer readable medium containing program code instructions executed by the processor) for executing the methods described herein. The set of instructions may be in the form of a program or software or app. The software may be in the form of system software or application software, for example. The software might also be in the form of a collection of separate programs, a program module within a larger program, or a portion of a program module, for example. The software used might also include modular programming in the form of object oriented programming. The software tells the processor what to do with the data being processed.

Further, it is appreciated that the instructions or set of instructions used in the implementation and operation of the invention may be in a suitable form such that the processor may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processor, i.e., to a particular type of computer, for example. Any suitable programming language may be used in accordance with the various embodiments of the invention. For example, the programming language used may include assembly language, Ada, APL, Basic, C, C++, COBOL, dBase, Forth, Fortran, Java, Modula-2, Pascal, Prolog, REXX, Visual Basic, and/or JavaScript. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of various embodiments of the invention may utilize any compression or encryption technique or algorithm, as may be desired. An encryption module might be used to encrypt data. Further, files or other data may be decrypted using a suitable decryption module, for example.

The software, hardware and services described herein may be provided utilizing one or more cloud service models, such as Software-as-a-Service (SaaS), Platform-as-a-Service (PaaS), and Infrastructure-as-a-Service (IaaS), and/or using one or more deployment models such as public cloud, private cloud, hybrid cloud, and/or community cloud models.

In the system and method of exemplary embodiments of the invention, a variety of “user interfaces” may be utilized to allow a user to interface with the mobile devices 128, 160 or personal computing devices 130, 140, 150. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor. The information provided by the user to the processor through the user interface may be in the form of a command, a selection of data, or some other input, for example.

Although the embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes.

1. A computer-implemented method for predicting job performance, the method comprising:
assigning a weight factor to each of a plurality of job attributes specified in a description of a job posting digitally stored on an electronic storage device;
removing invisible digital text from a plurality of digital resumes provided for the job posting and stored on the electronic storage device, wherein at least one digital resume is associated with a first digital file format and at least one other digital resume is associated with a second digital file format and, wherein the first and second digital file formats are distinct;
converting the plurality of digital resumes into a first set of parsed terms and the description of the job posting into a second set of parsed terms, wherein the second set of parsed terms comprises a description for a plurality of distinct job postings and, wherein the first and the second set of parsed terms are associated with a common digital file format distinct from the first and second digital file formats;
generating a Term Frequency-Inverse Document Frequency (TF-IDF) score for each term in the first and the second set of parsed terms to quantize a significance of each term in the plurality of digital resumes and the description of the job posting;
calculating, for each of the plurality of digital resumes, a similarity score with respect to the description of the job posting, wherein the similarity score is calculated based on the generated TF-IDF scores and the weight factor assigned to each of the plurality of job attributes specified in the description of the job posting; and
generating, a list of job applicants ordered according to the calculated similarity score with respect to the posted job opening.

2. The method of claim 1, further comprising:
applying a predictive model to the first set of parsed terms, to generate scores for each of the plurality of digital resumes indicating a predicted level of job performance.

3. The method of claim 1, further comprising using the first and the second set of parsed terms as inputs into a binary classification model to predict a likelihood of voluntary attrition in the first year of employment.

4. The method of claim 1, further comprising using the first and the second set of parsed terms as inputs into a regression model to predict job performance.

5. The method of claim 4, further comprising using actual job performance data to refine the model.

6. The method of claim 1, wherein the plurality of digital resumes comprise at least one digital resume converted from a resume image captured using one of a mobile phone, tablet computer, and scanning device.

7-18. (canceled)
